(19) United States
(12) Patent Application Publication
(10) Pub. No.: US 2026/0221703 A1
(43) Pub. Date: Jul. 30, 2026

(54) BUSBAR DEVICE

(71) Applicant: SCHNEIDER ELECTRIC (CHINA) CO., LTD., BEIJING (CN)

(72) Inventors: Jianliang HUANG, Guangzhou (CN); Xianfeng SONG, Guangzhou (CN); Tianwen LIN, Guangzhou (CN); Jianyuan HUANG, Guangzhou (CN)

(21) Appl. No.: 19/150,434

(22) PCT Filed: Sep. 14, 2023
(86) PCT No.: PCT/CN2023/118727

§ 371 Date: Jul. 23, 2025

(30) Foreign Application Priority Data
Oct. 27, 2022 (CN) 202211327939.X

(51) Int. Cl. H01R 25/14

(52) U.S. Cl. CPC H01R 25/145

(57) ABSTRACT

The present disclosure relates to a busbar device. The busbar device (100) comprises: a busbar connector (20) comprising at least one connection conductor (22) comprising an electrical contact surface and a first connection region and a second connection region disposed at different positions on the electrical contact surface, the connection conductor (22) being contactable with a first busbar (10) at the first connection region and a second busbar (10) at the second connection region to electrically connect the first busbar (10) with the second busbar (10). The first connection region and the second connection region each comprise a first conductive coating (25), such that the connection conductor (22) contacts corresponding busbars (10) at the first connection region and the second connection region via the first conductive coating (25) to form an electrical path. Thereby, the electrical contact performance at the busbar joint of the busbar device is improved.

### CROSS REFERENCE TO RELATED APPLICATIONS

The present application claims the priority of the Chinese patent application No. 202211327939.X entitled “Busbar Device” filed with the China National Intellectual Property Administration on Oct. 27, 2022, the entire disclosure of which is hereby incorporated by reference in its entirety.

### FIELD

Embodiments of the present disclosure generally relate to the field of power transmission, and particularly to a busbar device.

### BACKGROUND

Busbar devices are widely used in power systems to achieve power transmission. Busbars are usually made of aluminum or copper and are substantially in a flat shape, and busbars have a certain cross-sectional area which is sized in relation to a magnitude of an electrical current allowed to flow through the busbars. Multiple segments of busbars typically need to be connected to each other to extend the busbars.

After long-term use, the busbar usually has the problem of surface oxidation, which will cause contact resistance at the joint of the busbar device to increase significantly, thereby severely deteriorating conductive performances of the busbar device. In order to solve this problem, a bimetallic sheet is usually disposed in a joint region of the busbar to suppress oxidation. Although the bimetallic sheet can solve the above problem, manufacturing processes of the bimetallic sheet are complex and costly. In addition, the bimetallic sheet can only be disposed at a position suitable for spot welding, which causes arrangement region of the bimetallic sheet to be limited. It is desirable to improve the conventional busbar device.

### SUMMARY

Embodiments of the present disclosure provide a busbar device aiming to address one or more of the above-mentioned problems, as well as other potential problems.

According to a first aspect of the present disclosure, there is provided a busbar device. The busbar device comprises: a busbar connector comprising at least one connection conductor, the at least one connection conductor comprising an electrical contact surface and a first connection region and a second connection region disposed at different positions on the electrical contact surface, the connection conductor being contactable with a first busbar at the first connection region and being contactable with a second busbar at the second connection region to electrically connect the first busbar to the second busbar; wherein the first connection region and the second connection region each comprise a first conductive coating, such that the connection conductor contacts corresponding busbars at the first connection region and the second connection region via the first conductive coating to form an electrical path.

According to the busbar device of the present disclosure, oxidation resistance of the conductor may be effectively improved and thereby performances of the busbar device is improved by forming the conductive coating on the connection conductor of the busbar connector.

In some embodiments, the busbar device further comprises the first busbar and the second busbar, wherein each of the first busbar and the second busbar comprises a busbar connection region, and the first busbar and the second busbar contact the connection conductor through the respective busbar connection regions.

In some embodiments, a surface of the busbar connection region of at least one busbar of the first busbar and the second busbar is not subjected to a surface treatment. Thus, the costs may be further reduced and the cost-effectiveness in manufacturing the busbar device may be maintained.

In some embodiments, the connection conductor comprises a conductive body made of a first conductive material, and the first conductive coating is made of a second conductive material different from the first conductive material. Thus, improvements in oxidation resistance can be achieved by different materials.

In some embodiments, the first conductive coating is applied to the first connection region and the second connection region by cold spraying particles of the second conductive material. The coating is conveniently formed by cold spraying.

In some embodiments, the first conductive material is selected from one of copper and aluminum, and the second conductive material is at least one material selected from copper, silver and tin.

In some embodiments, a thickness of the first conductive coating is not less than 0.02 mm. Thus, the conductive coating can be ensured to exhibit its protective performance at a low cost.

In some embodiments, an extension length of the first conductive coating for forming the electrical path is not less than 3 times the thickness of the connection conductor. Thus, excellent electrical conductivity at the joint can be ensured.

In some embodiments, the busbar device comprises two said connection conductors for each phase of connection such that two opposite surfaces of the first busbar and the second busbar are in contact with the connection conductors, respectively. Thereby, a protection function may be provided at the surfaces of the both connection conductors.

In some embodiments, the busbar device comprises, for each phase of connection, one said connection conductor such that the first busbar and the second busbar are respectively in contact with the connection conductor at a single surface of each of the first busbar and the second busbar. Thereby, a protection function may be provided at the surface of the single connection conductor.

In some embodiments, the entire electrical contact surface of the connection conductor is provided with the first conductive coating.

In some embodiments, the busbar connection region of at least one busbar of the first busbar and the second busbar comprises a second conductive coating.

In some embodiments, the second conductive coating is formed by cold spraying a material that is different from a material of a busbar body of the at least one busbar.

In some embodiments, the busbar connection region of at least one busbar of the first busbar and the second busbar comprises an electroplated layer or is welded with a bimetallic cladding layer. Thereby, excellent performances of the busbar device may be achieved in a cost-effective manner.

### BRIEF DESCRIPTION OF THE DRAWINGS

The above and other objectives, features, and advantages of embodiments of the present disclosure will become more apparent from the following detailed description with reference to the accompanying drawings. In the figures, several embodiments of the present disclosure are shown in an exemplary but unrestrictive manner.

FIG. 1 illustrates a perspective view of a busbar device according to an embodiment of the present disclosure.

FIG. 2 illustrates an exploded view of a busbar device according to an embodiment of the present disclosure.

FIG. 3 illustrates a schematic view showing two busbars are in contact with connection conductors of a busbar connector according to one embodiment of the present disclosure.

FIG. 4 illustrates a schematic view showing two busbars are in contact with a connection conductor of a busbar connector according to another embodiment of the present disclosure.

FIG. 5 illustrates a schematic showing two busbars are in contact with connection conductors of a busbar connector according to a further embodiment of the present disclosure.

FIG. 6 illustrates a schematic view showing two busbars are in contact with a connection conductor of a busbar connector according to a further embodiment of the present disclosure.

FIG. 7 illustrates a schematic view of a system for cold spraying according to an embodiment of the present disclosure.

In all figures, the same or corresponding reference numbers denote the same or corresponding parts.

### DETAILED DESCRIPTION OF EMBODIMENTS

Preferred embodiments of the present disclosure will be described as follows in greater detail with reference to the drawings. Although preferred embodiments of the present disclosure are illustrated in the drawings, it is to be understood that the present disclosure described herein can be implemented in various manners, not limited to the embodiments illustrated herein. Rather, these embodiments are provided to make the present disclosure described herein clearer and more complete and convey the scope of the present disclosure described herein completely to those skilled in the art.

As used herein, the term “comprises” and its variants are to be read as open-ended terms that mean “comprises, but is not limited to.” The term “or” is to be read as “and/or” unless the context clearly indicates otherwise. The term “based on” is to be read as “based at least in part on.” The term “one example implementation” and “an example implementation” are to be read as “at least one example implementation.” The term “another implementation” is to be read as “at least one other implementation.” The terms indicating placement or positional relationship such as “up”, “down”, “front” and “rear” are based on the orientation or positional relationship shown in the figures, and are only for the convenience in describing the principles of the present disclosure, rather than indicating or implying that the designated elements must have a particular orientation, be constructed or operated in a particular orientation, and thus should not be construed as limiting the present disclosure.

A busbar made of copper or aluminum typically suffers from oxidation, which causes a significant increase in contact resistance. To this end, according to an embodiment of the present disclosure, there is provided a busbar device comprising a busbar connector. A conductive coating is formed on a connection region of a connection conductor of the busbar connector such that the busbar makes electrical contact with the connection conductor of the busbar connector through the conductive coating. In this way, the contact resistance is prevented from increasing due to oxidation at the joint. With the conductive coating being formed at the busbar connector, not only the forming method is simple, but also the conductive coating can be formed at any suitable position as desired, and performances of the busbar can be significantly improved. The busbar according to an embodiment of the present disclosure will be described in detail with reference to figures.

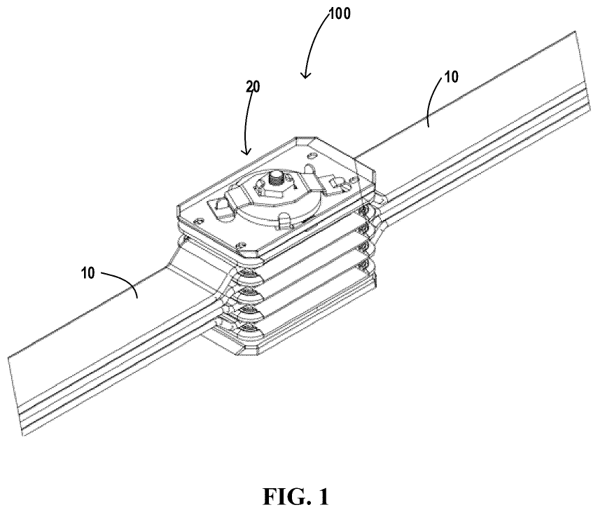

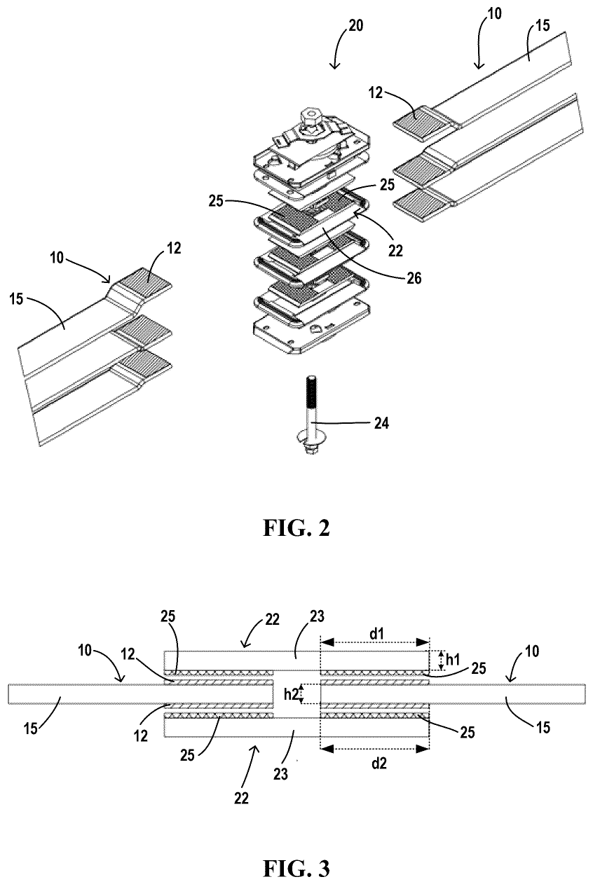

FIG. 1 and FIG. 2 respectively illustrate perspective views of a busbar device 100 according to an embodiment of the present disclosure. As shown in FIG. 1 and FIG. 2, the busbar device 100 may comprise a busbar connector 20 and longitudinally-extending busbars 10. The busbar connector 20 may be used to secure adjacent busbars 10 to each other to achieve an electrical path between the adjacent busbars.

The busbar 10 is formed to have a predetermined longitudinal length. The term “longitudinal” herein refers to an extension direction of the busbars, the extension direction coinciding with a current flow direction. A plurality of busbars 10 may be connected to each other to form extended busbars. Depending on a distance of power transmission, the plurality of busbars 10 may be longitudinally connected in series with each other to supply power to a desired place.

It should be appreciated that in the illustrated embodiment, two busbars to be in connected are connected longitudinally (i.e., the two busbars are connected at an angle 180°). It should be appreciated that this is exemplary only and that in other embodiments the two busbars to be connected may also be connected laterally (i.e., the two busbars are connected at an angle 180°) or at other angles. In addition, in the illustrated embodiment, the busbar device 100 is designed for three-phase power transmission and may comprises three rows of busbars arranged side-by-side. It should be appreciated that this is by way of example only, and the busbar device may comprise other numbers of busbars.

The busbar connector 20 may be used for connecting multiple phases of busbars, and may comprise a plurality of connection conductors 22, a plurality of insulating plates 26, a fastener 24, etc. The insulating plate 26 may be configured such that the connection conductors for different phases are electrically insulated from each other. A portion of the connection conductor 22 is in contact with one busbar and another portion of the connection conductor 22 is in contact with another busbar. As an example, the connecting conductor 22 and the insulating plate 26 may be provided with a through hole, and the fastener 24 (e.g., a bolt and a nut) may be used to secure the connection conductor 22, the insulating plates 26 and the adjacent busbars 10 together. Thus, the busbars 10 and the connection conductors 22 may be brought into pressure contact with each other. Adjacent busbars and connection conductors are pressure-mounted to each other by the fastener 24 to achieve electrical path of adjacent busbars.

In some embodiments, as shown in FIG. 1 and FIG. 2, the busbar connector 20 may comprise one or more connection conductors 22 for each phase. The connection conductor 22 comprises an electrical contact surface. The electrical contact surface of the connection conductor 22 contacts the busbar 10 to form the electrical path. The electrical contact surface may comprise a first connection region and a second connection region disposed at different positions thereon. The connection conductor 22 contacts a first busbar at the first connection region and contacts a second busbar at the second connection region. Thus, the first busbar and the second busbar may be electrically connected through the connection conductor.

As shown in FIG. 2, the first connection region and the second connection region each comprise a first conductive coating 25. The conductive coating 25 may extend across the electrical contact surface of the connection conductor. The connection conductor 22 contacts corresponding busbars 10 at the first connection region and the second connection region via the first conductive coating 25 to form the electrical path.

According to the embodiment of the present disclosure, defects caused by problems such as surface oxidation, galvanic corrosion and the like, of the busbars may be effectively prevented by providing the conductive coating (e.g., made of a material different from the material of a main body of the connection conductor) at the joint region of the connection conductor, and by realizing the electrical path of the busbars with other conductors through the conductive coatings.

In addition, since the electrical path is formed through the coatings, complexity of the process may be effectively reduced. In some embodiments, the coating may be pre-formed, for example, in a factory, and the user only needs to perform assembly operations in the field without need to perform an additional process such as welding, thereby reducing inconvenience in user's use as well as associated hardware and labor costs. In addition, the conductive coating can be conveniently formed using only a small amount of metal, which may reduce manufacturing costs of the busbar device.

In some embodiments, the coating may be formed using a cold spraying process, and the coating may be formed at any suitable location as desired. The coating may be applied so long as the shape or structural features of parts of the busbar do not interfere with the coating process. The conductive coating may be formed on the connection conductor 22 in many ways. By way of example, the conductive coating 25 may be applied to the contact surface region by cold spraying particles of a conductive material. An exemplary cold spraying method will be described in detail later with reference to FIG. 6. It should be appreciated that cold spraying is merely one example of forming the coating and that the conductive coating may be formed by any other suitable method.

In some embodiments, the connection conductor 22 comprises a conductive body 23 made of a first conductive material (e.g., aluminum or copper) (also referring to the embodiments shown in FIG. 3-FIG. 5). The conductive coating 25 is made of a second conductive material different from the first conductive material. As an example, the first conductive material of the conductive body 23 of the connection conductor may be made of copper or aluminum. The second conductive material for forming the conductive coating 25 is at least one material selected from a group consisting of copper, silver and tin. By way of example, silver, tin, copper, or a combination thereof may be coated on an aluminum surface (aluminum being employed as the material of the conductive body). Silver, tin, or a combination thereof is applied to a copper surface (copper being employed as the material of the conductive body). In some embodiments, only a silver layer, or only a tin layer, or only a copper layer is coated on the aluminum surface. In some embodiments, multiple metal layers of different materials may be coated on the aluminum surface, for example, a copper layer is coated first, and then a silver layer and/or a tin layer are/is coated. With such materials being employed, the aforementioned problems related to surface oxidation, surface galvanic corrosion and the like can be effectively suppressed.

In some embodiments, a thickness of the conductive coating is not less than 0.02 mm. Thus, the desired oxidation resistance can be achieved with an extremely thin conductive coating. In some embodiments, the thickness of the conductive coating may be 0.02 mm, 0.03 mm, 0.04 mm, 0.05 mm, 0.06 mm, 0.07 mm or larger.

In some embodiments, a longitudinal spray length of the conductive coating is not less than 3 times the thickness of the busbar body. Thereby, it can be ensured that the conductive coating effectively exhibits its performance. In some embodiments, the spray length of the conductive coating may be 4 times, 5 times, 6 times, 7 times, 8 times or more times the thickness of the busbar body. The term “spray length” herein refers to a length in the current flow direction when the connection conductor contacts another conductor, such as a busbar.

Structural details of connection arrangements of the bus connector and the bus will be described in detail with reference to FIG. 3-FIG. 6. FIG. 3-FIG. 6 respectively illustrate various exemplary connection arrangements of the busbar connector and busbars according to embodiments of the present disclosure. In the illustrated embodiments, connection for only one phase in the busbar connector is shown for sake of clarity. It should be appreciated that the connection the busbars in other phases may be implemented similarly.

In some embodiments, as shown in FIG. 3, the busbar device comprises two connection conductors 22 for each phase of connection. Two opposite surfaces of the first busbar and the second busbar are in contact with the connection conductors 22, respectively. As shown in FIG. 3, the busbar device may comprise two connection conductors 22. The two connection conductors 22 may be located on both sides of the busbar 10 and configured to contact the busbar 10 from surfaces of both sides of the busbar 10, respectively.

The connection conductor 22 comprises a conductive coating 25 at the contact surface to be in contact with the busbar. In the illustrated embodiment, the conductive coating 25 is formed in a region that makes electrical contact with the busbar 10. In other embodiments, the conductive coating 25 may be formed on the entire contact surface of the connection conductor. By way of example, the conductive coating 25 may be a cold-sprayed coating.

In the embodiment shown in FIG. 3, the busbar 10 may also be provided with a conductive coating 12. As shown in FIG. 3, the busbar 10 may comprise a busbar body 15 whose contact surface may further comprise a conductive coating 12. In the case where the busbar 10 is also provided with the conductive coating, performance sat the joint of the busbar device can be further improved.

In some embodiments, the conductive coating 12 may also be a cold-sprayed coating. In some other embodiments, the conductive coating 12 may be an electroplated layer, e.g., may be formed from a conductive material different from the busbar body 15 via electroplating. In some other embodiments, the conductive coating 12 may be a bi-metallic cladding layer that may be made of the same first material as the busbar body 15 and a second material different from the busbar body 14. The conductive coating 12 engages the busbar body 15 at the first material and contacts the conductive coating 25 of the connection conductor 22 at the second material.

FIG. 3 further shows a spray length d1 of the conductive coating 25. The spray length d1 may correspond to a longitudinal length of the joint region. The spray length d1 is not less than 3 times the thickness h1 of the conductor body 23 of the connection conductor 22. In some embodiments, the spray length of the conductive coating may be 4 times, 5 times, 6 times, 7 times, 8 times or more times the thickness of the busbar body. Similarly, FIG. 3 also shows a spray length d2 of the conductive coating 12, wherein the spray length d2 may correspond to the longitudinal length of the joint region. The spray length d2 is not less than 3 times the thickness h2 of the conductor body 15 of the busbar 10. In some embodiments, the longitudinal spray length of the conductive coating may be four, five, six, seven, eight or more times the thickness of the busbar body.

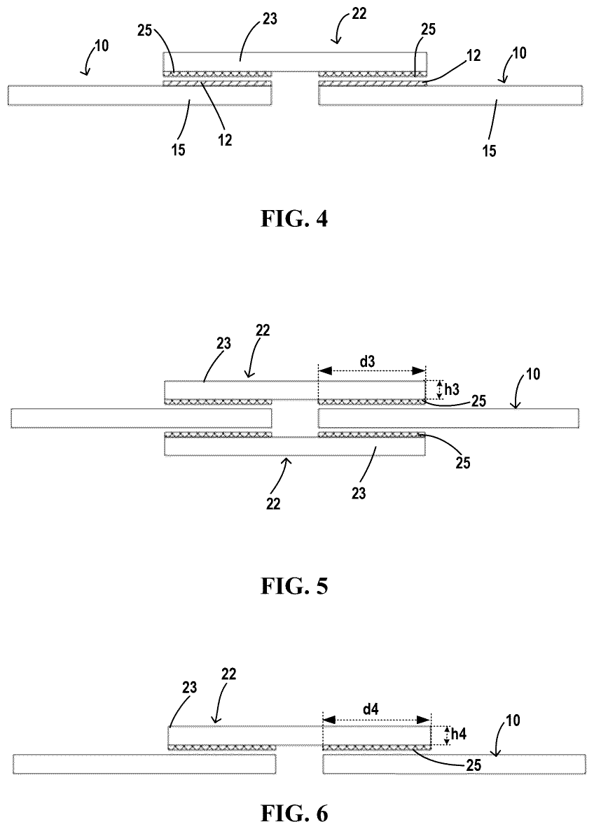

FIG. 4 illustrates another exemplary connection arrangement of a busbar connector and busbars according to an embodiment of the present disclosure. The embodiment shown in FIG. 4 is similar to that shown in FIG. 3. The difference lies in that in the embodiment shown in FIG. 4 the busbar device comprises one connection conductor 22 for each phase of connection. The first busbar and the second busbar are respectively in contact with the connection conductor 22 at a single surface. As shown in FIG. 4, the busbar device may comprise one connection conductor 22. The first busbar 10 and the second busbar 10 are in contact with the connection conductor 22 at the single surface.

The busbar 10 may also be provided with a conductive coating 12. As shown in FIG. 4, the busbar 10 may comprise a busbar body 15 whose contact surface may further comprise the conductive coating 12. In some embodiments, the conductive coating 12 may also be a cold-sprayed coating. In some other embodiments, the conductive coating 12 may be an electroplated layer, or a bi-metallic cladding layer.

FIG. 5 illustrates another exemplary connection arrangement of a busbar connector and busbars according to an embodiment of the present disclosure. The embodiment shown in FIG. 5 is similar to that shown in FIG. 3, except that the contact surfaces of the busbar in the embodiment shown in FIG. 5 are not subjected to any surface treatment. Since the busbars are not subjected to any surface treatment, the manufacturing cost of the busbar device may be further reduced.

In the embodiment of FIG. 5, the busbar 10 makes electrical contact with two connection conductors 22 at both surfaces. As shown in FIG. 5, the two connection conductors 22 of the busbar connector comprise a conductive coating 25 at the contact surfaces. The thickness of the conductive coating 25 is not less than 0.02 mm. Thus, the desired oxidation resistance can be achieved with an extremely thin conductive coating. The thickness of the conductive coating may also be 0.02 mm, 0.03 mm, 0.04 mm, 0.05 mm, 0.06 mm, 0.07 mm, 0.1 mm or larger.

FIG. 5 further shows a spray length d3 of the conductive coating 25, wherein the spray length d3 may correspond to the longitudinal length of the joint region. The spraying length d3 is not less than 3 times the thickness h3 of the conductor body 23 of the connection conductor 22. In some embodiments, the spray length of the conductive coating may be 4 times, 5 times, 6 times, 7 times, 8 times or more times the thickness of the busbar body.

FIG. 6 illustrates another exemplary connection arrangement of a busbar connector and busbars according to an embodiment of the present disclosure. The embodiment shown in FIG. 6 is similar to that shown in FIG. 5. In the embodiment of FIG. 6, the busbar 10 may contact a single connection conductor 22 at a single-sided surface to make an electrical path. As shown in FIG. 6, the connection conductor 22 of the busbar connector comprises a conductive coating 25 at the contact surface; the busbars are not subjected to any surface treatment. The thickness of the conductive coating 25 is not less than 0.02 mm. Thus, the desired oxidation resistance can be achieved with an extremely thin conductive coating. The thickness of the conductive coating may also be 0.02 mm, 0.03 mm, 0.04 mm, 0.05 mm, 0.06 mm, 0.07 mm, 0.1 mm or larger.

FIG. 6 further shows a spray length d4 of the conductive coating 25, wherein the spray length d4 may correspond to the longitudinal length of the joint region. The spraying length d3 is not less than 3 times the thickness h3 of the conductor body 23 of the connection conductor 22. In some embodiments, the spray length of the conductive coating may be 4 times, 5 times, 6 times, 7 times, 8 times or more times the thickness of the busbar body.

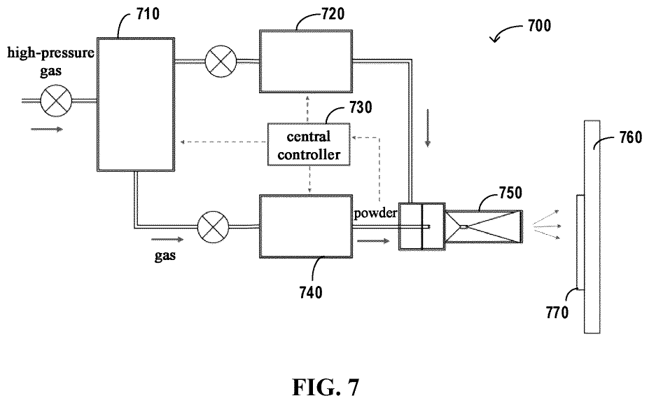

FIG. 7 illustrates a schematic view of a system 700 for cold spraying according to an embodiment of the present disclosure. The system 700 implements formation of the conductive coating, for example, using a high-speed cold spraying process.

As shown in FIG. 7, the system 700 may comprise a gas controller 710, a gas heating storage tank 720, a central controller 730, a metal powder tank 740, a spray gun 750, etc. A high-pressure gas is split under control by the gas controller 710. A portion of the split gas is delivered to the gas heating storage tank 720, and the remaining portion is delivered to the metal powder tank 740. The heated gas from the gas heating storage tank 720 is delivered to the spray gun 750 under the control of the central controller 730. Meanwhile, the powder in the metal powder tank 740 is delivered to the spray gun 750 (e.g., a Laval spray gun) under the action of the remaining portion of gas. At the spray gun 750, the heated high-speed gas, on the one hand, pre-heats the metal powder and, on the other hand, imparts kinetic energy to the powder. At the spray gun 750, the well-mixed powder fluid, during passage through a Laval nozzle, forms a high-speed fluid and splashes onto a substrate 760 and forms a mechanical anchoring bonding effect, thereby forming a coating 770 on the substrate 760. Controlled by the central controller 730, the fluid may be sprayed at a continuous high speed to form a coating of a corresponding thickness on the substrate as desired. The coating 770 can be conveniently formed in a proper region by properly selecting a spray region of the substrate 760. The coating formed by such a method may be used as the conductive coating 25 of the connection conductor 22. In some embodiments, such a method may also be used to form the conductive coating 12 of the busbars. It should be appreciated that system 700 is merely exemplary. The system 700 may include any other suitable implementation.

In addition, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein. Certain features that are described in the context of separate implementations may also be implemented in combination in a single implementation. Rather, various features described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A busbar device (100), comprising:
a busbar connector (20) comprising at least one connection conductor (22), the at least one connection conductor (22) comprising an electrical contact surface and a first connection region and a second connection region disposed at different positions on the electrical contact surface, the connection conductor (22) being contactable with a first busbar (10) at the first connection region and being contactable with a second busbar (10) at the second connection region to electrically connect the first busbar (10) to the second busbar (10),
wherein the first connection region and the second connection region each comprise a first conductive coating (25) such that the connection conductor (22) contacts corresponding busbars at the first connection region and the second connection region via the first conductive coating (25) to form an electrical path.

2. The busbar device (100) according to claim 1, wherein the busbar device further comprises the first busbar (10) and the second busbar (10), wherein each of the first busbar (10) and the second busbar (10) comprises a busbar connection region, and the first busbar (10) and the second busbar (10) contact the connection conductor (25) at the respective busbar connection regions.

3. The busbar device (100) according to claim 2, wherein a surface of the busbar connection region of at least one busbar (10) of the first busbar (10) and the second busbar (10) is not subjected to a surface treatment.

4. The busbar device (100) according to claim 1, wherein the connection conductor (22) comprises a conductive body (23) made of a first conductive material, and the first conductive coating (25) is made of a second conductive material different from the first conductive material.

5. The busbar device (100) according to claim 4, wherein the first conductive coating (25) is applied to the first connection region and the second connection region by cold spraying particles of the second conductive material.

6. The busbar device (100) according to claim 4, wherein the first conductive material is selected from one of copper and aluminum, and the second conductive material is at least one material selected from copper, silver, and tin.

7. The busbar device (100) according to claim 4, wherein a thickness of the first conductive coating (25) is not less than 0.02 mm.

8. The busbar device (100) according to claim 4, wherein an extension length of the first conductive coating (25) for forming the electrical path is not less than 3 times a thickness of the connection conductor (22).

9. The busbar device (100) according to claim 1, wherein the busbar device comprises, for each phase of connection, two said connection conductors (22), such that two opposite surfaces of the first busbar (10) and the second busbar (10) are in contact with the connection conductors (22), respectively.

10. The busbar device (100) according to claim 1, wherein the busbar device comprises, for each phase of connection, one said connection conductor (22), such that the first busbar (10) and the second busbar (10) are respectively in contact with the connection conductor at a single surface of each of the first busbar (10) and the second busbar (10).

11. The busbar device (100) according to claim 1, wherein an entire electrical contact surface of the connection conductor (22) is provided with the first conductive coating (25).

12. The busbar device (100) according to claim 1, wherein the busbar connection region of at least one busbar of the first busbar (10) and the second busbar (10) comprises a second conductive coating (12).

13. The busbar device (100) according to claim 12, wherein the second conductive coating (12) is formed by cold spraying a material that is different from a material of a busbar body of the at least one busbar.

14. The busbar device (100) according to claim 1, wherein the busbar connection region of at least one busbar of the first busbar (10) and the second busbar (10) comprises an electroplated layer or is welded with a bimetallic cladding layer.
